(19) United States
(12) Patent Application Publication
(10) Pub. No.: US 2016/0218788 A1
(43) Pub. Date: Jul. 28, 2016

(54) METHOD AND APPARATUS FOR TRANSMITTING CHANNEL STATE INFORMATION

(71) Applicant: LG ELECTRONICS INC., Seoul (KR)

(72) Inventors: Kunil YUM, Seoul (KR); Yunjung YI, Seoul (KR); Hanbyul SEO, Seoul (KR); Kijun KIM, Seoul (KR); Daesung HWANG, Seoul (KR); Bonghoe KIM, Seoul (KR)

(73) Assignee: LG ELECTRONICS INC., Seoul (KR)

(21) Appl. No.: 15/009,486

(22) Filed: Jan. 28, 2016

Related U.S. Application Data
(60) Provisional application No. 62/109,048, filed on Jan. 28, 2015.
(60) Provisional application No. 62/161,262, filed on May 14, 2015.

(51) Int. Cl. H04B 7/06; H04W 72/04

(52) U.S. Cl. CPC H04B 7/0626; H04W 72/042

(57) ABSTRACT

A method for transmitting a channel state report considering repetition for coverage enhancement in a wireless communication system, the method being performed by a terminal includes receiving information on a reference resource period, determining a plurality of valid downlink subframes in the reference resource period using the information, and calculating channel state information in the plurality of valid downlink subframes. The number of valid downlink subframes is equal to the number of the repetition.

### CROSS-REFERENCE TO RELATED APPLICATIONS

This application claims the benefit of the U.S. Provisional Application Nos. 62/109,048, filed on Jan. 28, 2015 and 62/161,262, filed on May 14, 2015, which are hereby incorporated by reference as if fully set forth herein.

### BACKGROUND OF THE INVENTION

1. Field of the Invention

The present invention relates to a wireless communication system, and more particularly, to a method and apparatus for transmitting channel state information (CSI). Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed a method and apparatus for transmitting channel state information (CSI) that substantially obviate one or more problems due to limitations and disadvantages of the related art.

An object of the present invention is to provide a method for transmitting channel state information (CSI) in a wireless communication system, to which coverage enhancement applies, for more efficient channel state report and appropriate scheduling.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting a channel state report considering repetition for coverage enhancement in a wireless communication system is performed by a terminal and includes receiving information on a reference resource period, determining a plurality of valid downlink subframes in the reference resource period using the information, and calculating channel state information in the plurality of valid downlink subframes, wherein the number of valid downlink subframes is equal to the number of the repetition.

Additionally or alternatively, the valid downlink subframes may include a subframe not used as a gap subframe for frequency re-tuning for subband hopping or a subframe other than a subframe configured as a gap by a network for re-tuning.

Additionally or alternatively, the valid downlink subframes may include a subframe configured as a subframe in which the terminal receives downlink data and/or a control channel.

Additionally or alternatively, the valid downlink subframes may include a subframe configured as a measurement gap when the measurement gap for subband measurement is configured for the terminal.

Additionally or alternatively, the valid downlink subframes may include a subframe configured to monitor a subband included in a subband set for which the terminal calculates a channel quality indicator.

Additionally or alternatively, the valid downlink subframes may include a subframe in which the terminal performs channel measurement within a time duration in a monitored subband, and the time duration may include a duration when a result value of channel measurement is assumed to be valid.

Additionally or alternatively, the reference resource period may include subframes after a subframe in which a request for an aperiodic channel state information is received.

Additionally or alternatively, the information on the reference resource period may include information on a start subframe and last subframe of the reference resource period.

Additionally or alternatively, the information on the reference resource period may include a start subframe of the reference resource period and information on a length of the reference resource period.

In another aspect of the present invention, a terminal configured to transmit a channel state report considering repetition for coverage enhancement in a wireless communication system includes a radio frequency (RF) unit and a processor configured to control the RF unit, wherein the processor receives information on a reference resource period, determines a plurality of valid downlink subframes in the reference resource period using the information, and calculates channel state information in the plurality of valid downlink subframes, and wherein the number of valid downlink subframes is equal to the number of the repetition.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing an example of a radio frame structure used in a wireless communication system;

FIG. 2 is a diagram showing an example of a downlink/uplink (DL/UL) slot structure in a wireless communication system;

FIG. 3 is a diagram showing a downlink (DL) subframe structure used in a 3GPP LTE/LTE-A system;

FIG. 4 is a diagram showing an example of an uplink (UL) subframe structure used in a 3GPP LTE/LTE-A system;

FIG. 5 is a diagram showing downlink control information format 1 according to one embodiment of the present invention;

FIG. 6 is a diagram showing DCI format 2 according to one embodiment of the present invention;

FIG. 7 is a diagram showing an example of transmitting a repetition level instead of RI via a repetition level indicator (RLI);

FIG. 8 is a diagram showing a reference resource period according to one embodiment of the present invention;

FIG. 9 is a diagram showing a reference resource period according to one embodiment of the present invention;

FIG. 10 is a diagram showing a reference resource period according to one embodiment of the present invention;

FIG. 11 is a diagram showing a reference resource period according to one embodiment of the present invention;

FIG. 12 is a diagram showing a reference resource period according to one embodiment of the present invention; and

FIG. 13 is a block diagram showing an apparatus for implementing the embodiment(s) of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

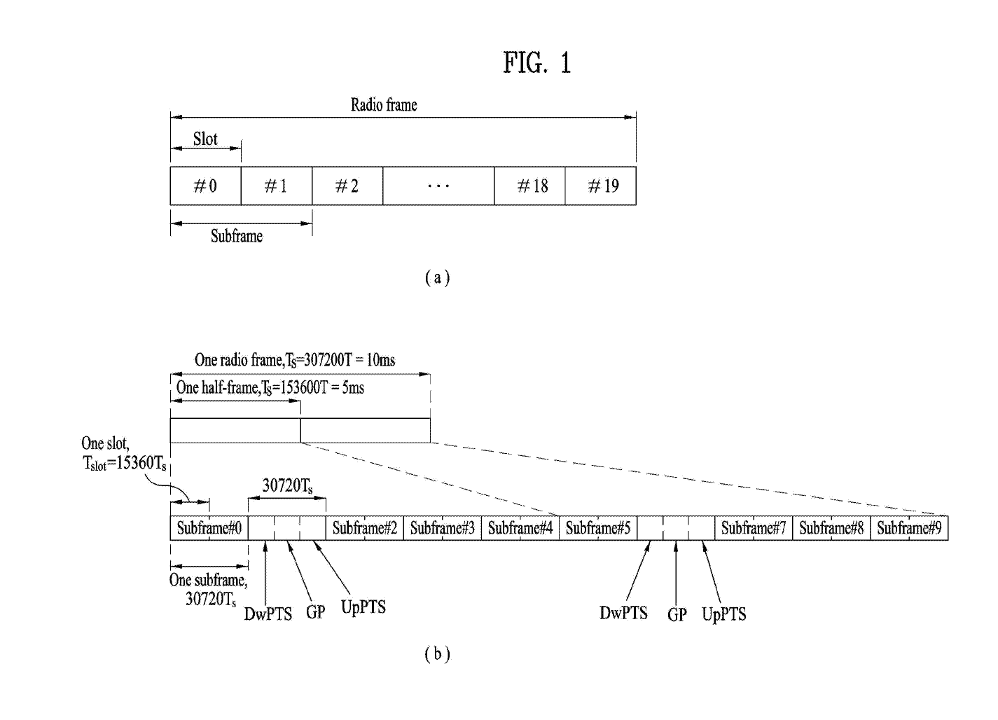

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink-to- | | | | | | | | | | |
|---|---|---|---|---|---|---|---|---|---|---|---|
| DL-UL | Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

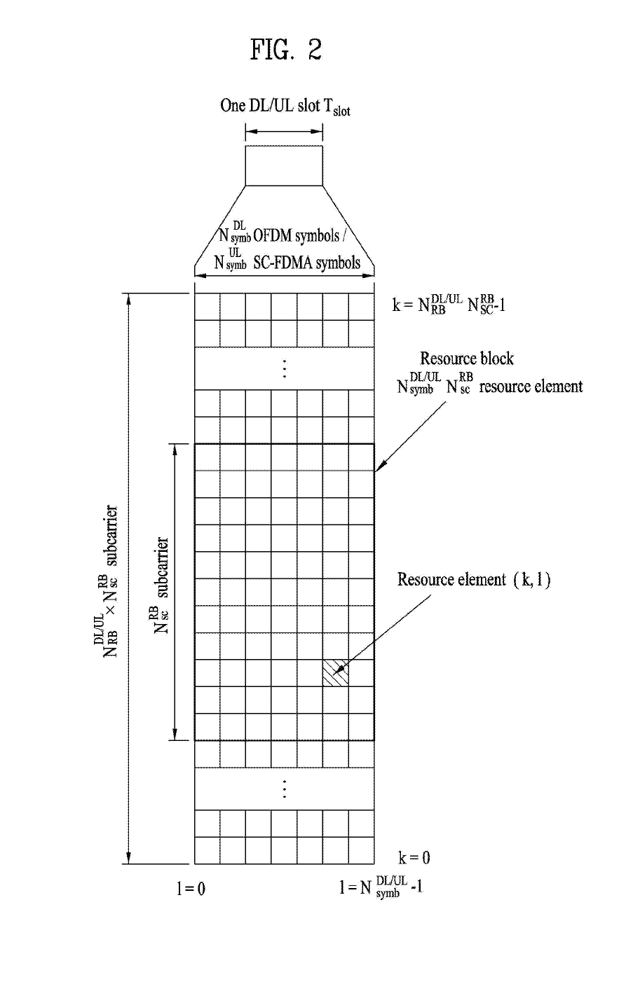

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/Ul} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

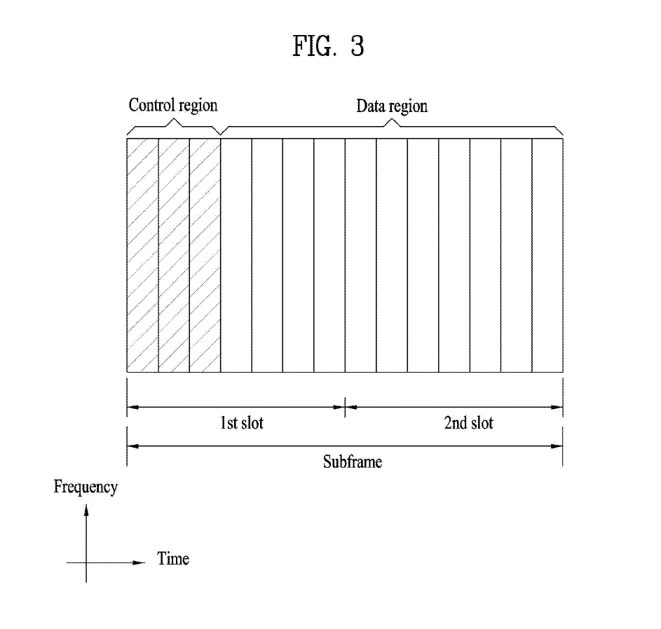

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation Level | | Number of PDCCH |
| Type | L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CUES according to CCE, aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

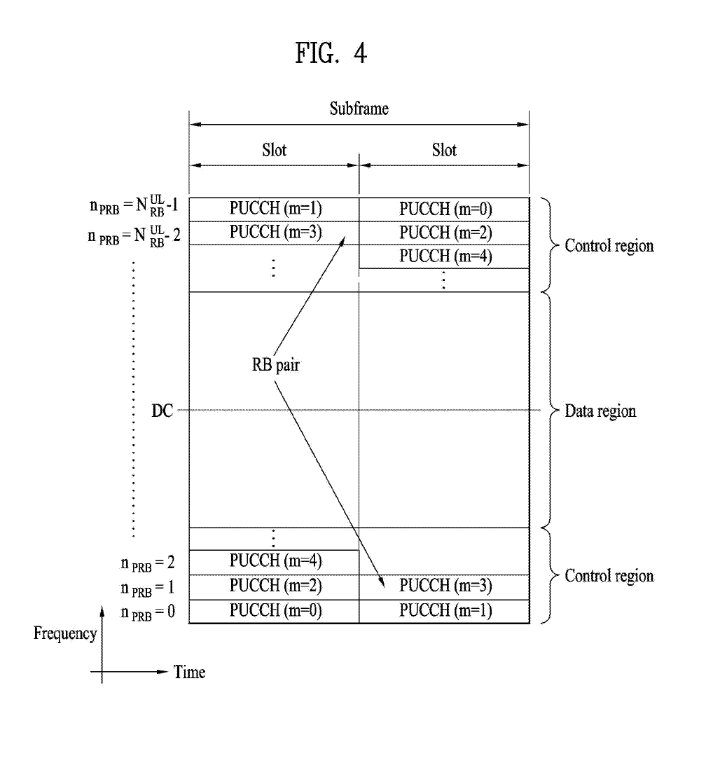

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.

Scheduling Request (SR): This is information used to request a UL-SCH resource and is transmitted using On-Off Keying (OOK) scheme.

HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (HACK), discontinuous transmission (DTX) and NACK/DTX. Here, the term HARQ-ACK is used interchangeably with the term HARQ ACK/NACK and ACK/NACK.

Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon. Table 4 shows the mapping relationship between PUCCH formats and UCI in LTE/LTE-A.

TABLE 4

| | | Number | | |
|---|---|---|---|---|
| | Modu- | of bits per | | |
| PUCCH | lation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUCCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

CSI Report

In a 3GPP LTE(-A) system, a user equipment (UE) reports channel state information (CSI) to a base station (BS) and CSI refers to information indicating quality of a radio channel (or a link) formed between the UE and an antenna port. For example, the CSI includes a rank indicator (RI), a precoding matrix indicator (PMI), a channel quality indicator (CQI), etc. Here, the RI indicates rank information of a channel and means the number of streams received by the UE via the same time-frequency resources. Since the value of the RI is determined depending on long term fading of the channel, the RI is fed from the UE back to the BS with periodicity longer than that of the PMI or the CQI. The PMI has a channel space property and indicates a precoding index preferred by the UE based on a metric such a signal to interference plus noise ratio (SINR). The CQI indicates the strength of the channel and means a reception SINR obtained when the BS uses the PMI.

Based on measurement of the radio channel, the UE may calculate a preferred PMI and RI, which may derive an optimal or best transfer rate when used by the BS, in a current channel state and feed the calculated PMI and RI back to the BS. The CQI refers to a modulation and coding scheme for providing acceptable packet error probability for the fed-back PMI/RI.

Meanwhile, in an LTE-A system which includes more accurate MU-MIMO and explicit CoMP operations, current CSI feedback is defined in LTE and thus may not sufficiently support operations to be newly introduced. As requirements for CSI feedback accuracy become more complex in order to obtain sufficient MU-MIMO or CoMP throughput gain, the PMI is composed of two PMIs such as a long term/wideband PMI (W1) and a short term/subband PMI (W2). In other words, a final PMI is expressed by a function of W1 and W2. For example, the final PMI W may be defined as follows: W=W1*W2 or W=W2*W1. Accordingly, in LTE-A, a CSI may be composed of RI, W1, W2 and CQI.

In the 3GPP LTE(-A) system, an uplink channel used for CSI transmission is shown in Table 5 below.

TABLE 5

Scheduling scheme Periodic CSI transmission Aperiodic CSI

transmission

Frequency non-selective PUCCH -
Frequency selective PUCCH PUSCH

Referring to Table 5, the CSI may be transmitted using a physical uplink control channel (PUCCH) with periodicity determined by a higher layer or may be aperiodically transmitted using a physical uplink shared channel (PUSCH) according to the demand of a scheduler. If the CSI is transmitted using the PUSCH, only frequency selective scheduling method and an aperiodic CSI transmission method are possible. Hereinafter, the scheduling scheme and a CSI transmission scheme according to periodicity will be described.

1) CQI/PMI/RI Transmission via PUSCH after Receiving CSI Transmission Request Control Signal.

A control signal for requesting transmission of a CSI may be included in a PUSCH scheduling control signal (UL grant) transmitted via a PDCCH signal. Table 5 below shows the mode of the UE when the CQI, the PMI and the RI are transmitted via the PUSCH.

TABLE 6

| | | PMI Feedback Type | | |
|---|---|---|---|---|
| | | No PMI | Single PMI | Multiple PMIs |
| PUSCH CQI | Wideband | | | Mode 1-2 |
| Feedback Type | (Wideband CQI) | | | RI |
| | | | | 1st wideband |
| | | | | CQI(4 bit) |
| | | | | 2nd wideband |
| | | | | CQI(4 bit) |
| | | | | if RI > 1 |
| | | | | N*Subband |
| | | | | PMI(4 bit) |
| | | | | (N is the total # of |
| | | | | subbands) |
| | | | | (if 8Tx Ant, |
| | | | | N*subband W2 + |
| | | | | wideband W1) |
| | UE selected | Mode 2-0 | | Mode 2-2 |
| | (Subband CQI) | RI (only for Open- | | RI |
| | | loop SM) | | 1st wideband |
| | | 1st wideband | | CQI(4 bit) + Best-M |
| | | CQI(4 bit) + Best-M | | CQI(2 bit) |
| | | CQI(2 bit) | | 2nd wideband |
| | | (Best-M CQI; | | CQI(4 bit) + Best-M |
| | | average CQI for | | CQI(2 bit) if RI > 1 |
| | | selected M SB(s) | | Best-M index (L |
| | | among N SBs) | | bit) |
| | | Best-M index (L | | Wideband |
| | | bit) | | PMI(4 bit) + Best-M |
| | | | | PMI(4 bit) |
| | | | | (if 8Tx Ant, |
| | | | | wideband W2 + |
| | | | | Best-M W2 + |
| | | | | wideband W1) |
| | Higher Layer- | Mode 3-0 | Mode 3-1 | Mode 3-2 |
| | configured | RI (only for Open- | RI | RI |
| | (Subband CQI) | loop SM) | 1st wideband | 1st wideband |
| | | 1st wideband | CQI(4 bit) + | CQI(4 bit) + |
| | | CQI(4 bit) + | N*subbandCQI(2 bit) | N*subbandCQI(2 bit) |
| | | N*subbandCQI(2 bit) | 2nd wideband | 2nd wideband |
| | | | CQI(4 bit) + | CQI(4 bit) + |
| | | | N*subbandCQI(2 bit) | N*subbandCQI(2 bit) |
| | | | if RI > 1 | if RI > 1 |
| | | | Wideband | N*Subband |
| | | | PMI(4 bit) | PMI(4 bit) |
| | | | (if 8Tx Ant, | (N is the total # of |
| | | | wideband W2 + | subbands) |
| | | | wideband W1) | (if 8Tx Ant, |
| | | | | N*subband W2 + |
| | | | | wideband W1) |

The transmission mode of Table 6 is selected at a higher layer and the CQI/PMI/RI is transmitted in the same PUSCH subframe. Hereinafter, an uplink transmission method of the UE according to mode will be described.

Mode 1-2 indicates the case in which a precoding matrix is selected on the assumption that data is transmitted via only a subband with respect to each subband. The UE generates a CQI on the assumption that a precoding matrix is selected with respect to an entire set S specified by a higher layer or a system bandwidth. In Mode 1-2, the UE may transmit the CQI and the PMI value of each subband. At this time, the size of each subband may be changed according to system bandwidth.

In mode 2-0, the UE may select M preferred subbands with respect to the set S specified at the higher layer or the system bandwidth. The UE may generate one CQI value on the assumption that data is transmitted with respect to the selected M subbands. The UE preferably reports one CQI (wideband CQI) value with respect to the set S or the system bandwidth. The UE defines the CQI value of each codeword in the form of a difference if a plurality of codewords is present with respect to the selected M subbands.

At this time, the differential CQI value is determined by a difference between an index corresponding to the CQI value of the selected M subbands and a wideband CQI (WB-CQI) index.

In Mode 2-0, the UE may transmit a CQI value generated with respect to a specified set S or an entire set and one CQI value for the selected M subbands to the BS. At this time, the size of the subband and the M value may be changed according to system bandwidth.

In Mode 2-2, the UE may simultaneously select the locations of M preferred subbands and a single precoding matrix for the M preferred subbands on the assumption that data is transmitted via the M preferred subbands. At this time, the CQI value for the M preferred subbands is defined per codeword. In addition, the UE further generates a wideband CQI value with respect to the specified set S or the system bandwidth.

In Mode 2-2, the UE may transmit information about the locations of the M preferred subbands, one CQI value for the selected M subbands, a single PMI for the M preferred subbands, a wideband PMI and a wideband CQI value to the BS. At this time, the size of the subband and the M value may be changed according to system bandwidth.

In Mode 3-0, the UE generates a wideband CQI value. The UE generates the CQI value for each subband on the assumption that data is transmitted via each subband. At this time, even in case of RI>1, the CQI value indicates only the CQI value for a first codeword.

In Mode 3-1, the UE generates a single precoding matrix with respect to the specified set S or the system bandwidth. The UE generates a subband CQI on a per codeword basis on the assumption of the single precoding matrix generated with respect to each subband. In addition, the UE may generate a wideband CQI on the assumption of a single precoding matrix. The CQI value of each subband may be expressed in the form of a difference. The subband CQI value is calculated by a difference between a subband CQI index and a wideband CQI index. At this time, the size of the subband may be changed according to system bandwidth.

In Mode 3-2, the UE generate a precoding matrix for each subband instead of a single precoding matrix for system bandwidth, to be compared with Mode 3-1.

2) Periodic CQI/PMI/RI Transmission via PUCCH

The UE may periodically transmit the CSI (e.g., CQI/PMI/RI information) to the BS via the PUCCH. If the UE receives a control signal for requesting transmission of user data, the UE may transmit the CQI via the PUCCH. Even when the control signal is transmitted via the PUSCH, the CQI/PMI/RI may be transmitted using one of the modes defined in Table 7 below.

TABLE 7

PMI feedback type

| | | No PMI | Single PMI |
|---|---|---|---|
| PUCCH CQI | Wideband | Mode 1-0 | Mode 1-1 |
| feedback type | (wideband CQI) | | |
| | UE selection | Mode 2-0 | Mode 2-1 |
| | (subband CQI) | | |

The UE may have the transmission modes shown in Table 7. Referring to Table 7, in Mode 2-0 and Mode 2-1, a bandwidth (BP) part is a set of subbands continuously located in a frequency domain and may cover a system bandwidth or a specified set S. In Table 7, the size of each subband, the size of the BP and the number of BPs may be changed according to system bandwidth. In addition, the UE transmits the CQI in a frequency domain in ascending order per BP so as to cover the system bandwidth or the specified set S.

According to a transmission combination of the CQI/PMI/RI, the UE may have the following four transmission types.

i) Type 1: A subband CQI (SB-CQI) of Mode 2-0 and Mode 2-1 is transmitted.

ii) Type 1a: A subband CQI and a second PMI are transmitted.

iii) Type 2, Type 2b, Type 2c: A wideband CQI and a PMI (WB-CQI/PMI) are transmitted.

iv) Type 2a: A wideband PMI is transmitted.

v) Type 3: An RI is transmitted.

vi) Type 4: A wideband CQI is transmitted.

vii) Type 5: An RI and a wideband PMI are transmitted.

viii) Type 6: An RI and a PTI are transmitted.

If the UE transmits the RI and the wideband CQI/PMI, the CQI/PMI is transmitted in subframes having different offsets and periodicities. In addition, if the RI and the wideband CQI/PMI should be transmitted in the same subframe, the CQI/PMI is not transmitted.

Machine type communication (MTC) is a communication method for performing communication without human intervention. As a representative application of MTC, smart metering may be considered. This is an application of attaching a communication module to a meter such as an electric meter, a gas meter or a water meter and periodically transmitting measurement information. A smart meter for performing such operation is mounted in an environment having poor propagation properties such as a basement. When a relay is mounted in order to solve this problem, costs increase. Accordingly, in MTC operating in an environment having a poor propagation property, downlink and uplink channels are repeatedly transmitted to efficiently provide stable communication. The present invention proposes a channel status information (CSI) measurement and transmission method for a UE for performing coverage enhancement (CE) via repetitive data transmission.

CSI Report

A channel quality indicator (CQI) defined in the LTE-A standard is as follows.

A single PDSCH transport block with a combination of modulation scheme and transport block size corresponding to the CQI index, and occupying a group of downlink physical resource blocks termed the CSI reference resource, could be received with a transport block error probability not exceeding 0.1.

Existing CSI is calculated using one reference subframe but an MTC UE for performing CE repeatedly transmits one PDSCH over several subframes. Accordingly, when the CQI is determined on the assumption that one PDSCH is transmitted in one subframe, a CQI remarkably lower than a CQI achieved by performing CE is obtained. This may violate the above CQI definition. Accordingly, when the UE calculates and transmits CSI thereof, CSI considering CE performed thereby may be transmitted. This appears as a repetition number and there is a need for determining the repetition number.

Method 1: Designation of Repetition Number at eNB

In this method, an eNB designates a repetition number to be used to calculate the CSI at the UE. The eNB may designate the repetition number to be used by the UE based on a measurement result such as radio resource management (RRM) and signal the repetition number to the UE. This may be signaled from the eNB to the UE via a control message such as DCI or RRC.

Method 1-1: Transmission via RRC

An eNB may notify a UE of a repetition number to be used for CSI calculation at the UE. The eNB may directly designate a specific repetition number via RRC or designate one of the repetition numbers signaled to the UE to be used for a PDSCH or a PDCCH.

Method 1-2: Transmission via DCI

An eNB may notify a UE of a repetition number to be used for CSI calculation at the UE. When the UE receives the repetition number from the eNB, the UE calculates and transmits a CQI considering the repetition number. In this case, when the repetition number received from the eNB is N, the UE may assume that a PDSCH is repeatedly transmitted over N subframes and calculate the CQI.

The eNB may directly signal a specific repetition number to the UE or define a table or equation as shown in the following table and transmit an index corresponding to a repetition number to indicate the repetition number.

TABLE 8

| index | repetition number |
|---|---|
| 0 | 1 |
| 1 | 10 |
| 2 | 20 |
| 3 | 50 |

The above table shows an example when a 2-bit container is assigned to DCI. The table or equation may be predefined between the eNB and the UE or may be transmitted from the UE to the eNB or from the eNB to UE using a method such as RRC signaling.

The table indicating such a CE degree may be determined according to a maximum CE repetition number configured by a network. For example, when the maximum CE repetition number configured by the network is 100, the following table may be considered. In such a table, a CE repetition number of each index may be changed according to a maximum coverage level provided by a system.

TABLE 9

| Index | repetition number |
|---|---|
| 0 | 1 |
| 1 | 10% * max = 10 |
| 2 | 50% * max = 50 |
| 3 | 100% * max = 100 |

The UE may not directly transmit the repetition number but transmit only an offset. For example, the UE may transmit “00”=no change/“01”increase/“10”=decrease as a repetition number of downlink/uplink using 2 bits. For example, when 01 is transmitted, the UE may increase the repetition number used for CSI calculation by one. The increment may be predefined or may be transmitted from the eNB to the UE via signaling such as RRC signaling.

Alternatively, increase/decrease in the repetition number of uplink/downlink may be defined as in the following table.

TABLE 10

| Index | repetition number |
|---|---|
| 0 | x1 |
| 1 | x2 |
| 2 | /2 |
| 3 | x4 |

In this case, the UE may transmit the index=“10” to indicate that the repetition number is halved.

The repetition number may be determined according to the maximum CE repetition number configured by the network. For example, when the maximum CE repetition number configured by the network is 100, the following table may be considered.

TABLE 11

| Index | repetition number |
|---|---|
| 0 | no change |
| 1 | +10% * 100 = +10 |
| 2 | −10% * 100 = −10 |
| 3 | +20% * 100 = +20 |

The above table may be defined or configured by the eNB.

Information on the repetition number may be transmitted by defining a new container in a DCI format. This method may be mainly considered when making a new DCI format for an MTC UE.

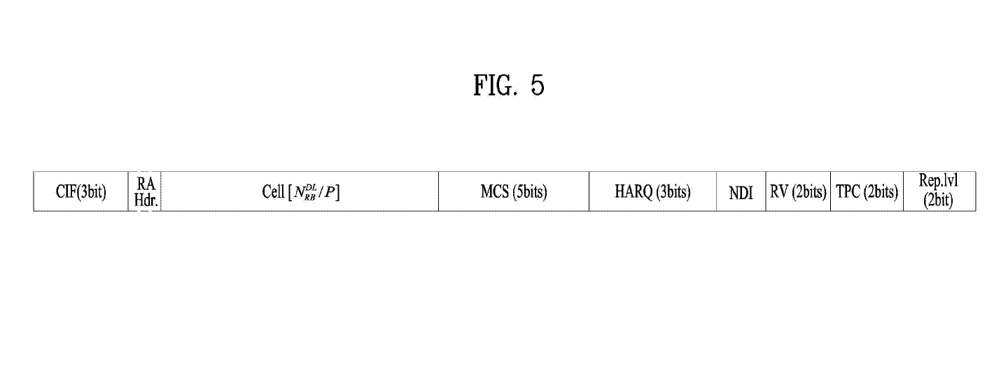

For example, in DCI format 1, modification may be made as shown in FIG. 5.

That is, a container (e.g., a 2-bit container) for transmitting a repetition number denoted by “Rep.1v1” in FIG. 5 may be attached to an existing DCI format.

Alternatively, an existing container may be reused. For example, in DCI 2 series, a container for transmitting information on a second codeword may be used. The MTC UE may perform transmission of only one layer, for cost reduction. In this case, since an MCS/NDI/RV container for a second codeword is not used, the container may be used to transmit the repetition number.

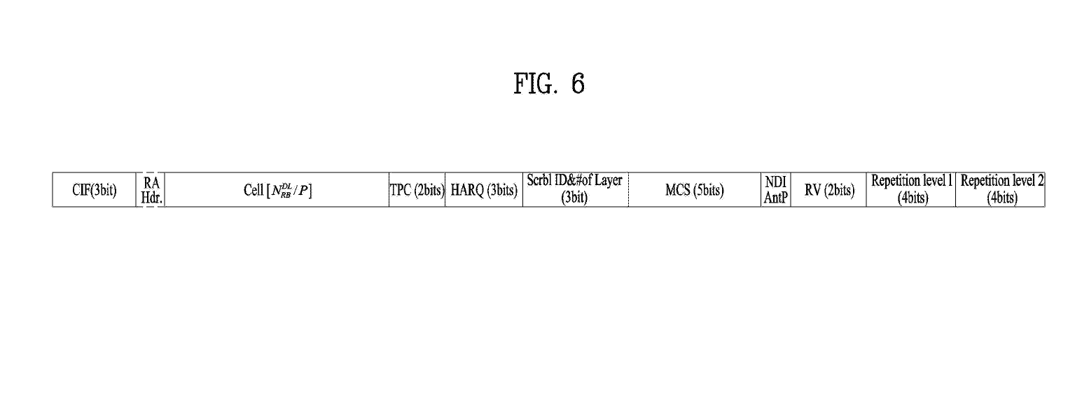

FIG. 6 shows an example of transmitting two kinds of repetition numbers via an 8-bit container of DCI format 2C. Each repetition number may be used for different points such as different channels. In this case, since the size of each container is 4 bits, one of a maximum of 16 kinds of repetition numbers may be designated.

Alternatively, information on the repetition number may be transmitted via CRC. When DCI is transmitted, the eNB masks the DCI using a C-RNTI and the UE checks integrity of information received using the same RNTI. Accordingly, when different RNTIs are used according to repetition number, the UE selects a group RNTI with CRC, that is, with integrity, from candidates of an RNTI set to check the repetition number indicated by information.

TABLE 12

| RNTI | |
|---|---|
| number | repetition number |
| 0 | 1 |
| 1 | 20 |
| 2 | 50 |
| 3 | 100 |

In case of an aperiodic CSI request, in addition to the repetition number or repetition level indicated by the DCI, a repetition number applied to calculate aperiodic CSI may be designated via an aperiodic CSI request as shown in the following table.

TABLE 13

| Aperiodic CSI | |
|---|---|
| request | Aperiodic CSI |
| 0 | no report |
| 1 | aperiodic CSI with current repetition level |
| 2 | aperiodic CSI with 1^{st} configured repetition level |
| 3 | aperiodic CSI with 2^{nd} configured repetition level |

Alternatively, the repetition number may be designated as shown in the following table.

TABLE 14

| Aperiodic CSI | |
|---|---|
| request | Aperiodic CSI |
| 0 | no report |
| 1 | aperiodic CSI with current repetition level |
| 2 | aperiodic CSI with repetition level +10 than current |
| | repetition number |
| 3 | aperiodic CSI with repetition level −10 than current |
| | repetition number |

In the above table, increment of the repetition number such as ±10 may be received from or transmitted to the eNB via RRC signaling.

When reception of DCI fails or during an RRC reconfiguration period, ambiguity of the repetition number may occur. In this case, the repetition number of the period may be defined using the following method.

Use of existing repetition number:

A last repetition number received before RRC reconfiguration is performed or when DCI is missed is used until reception of next DCI/RRC signaling succeeds.

Use of repetition number pre-designated via RRC:

A default repetition number designated via RRC signaling or designated previously is used for CSI calculation or another channel.

Use of repetition number used in another channel in this instance

For example, when CSI received via an aperiodic CSI request is received, the eNB selects one of a common search space (CSS) or a user-specific search space (USS) and transmits DCI including the aperiodic CSI request. At this time, the UE may assume and calculate a repetition number used for the control channel, via which the aperiodic CSI request is received, when a specific repetition number is not designated at certain timing.

Method 2: Transmission of repetition level used for CSI calculation at UE along with CSI

The UE may not receive a repetition level designated by the eNB but may assume an appropriate repetition level based on a channel measured thereby. In this case, the UE may transmit CSI and a repetition level used for CSI calculation to the eNB. The eNB may designate an appropriate repetition number with respect to the UE based on the received repetition level or may directly transmit the repetition number to the UE instead of the repetition level. A relationship between the repetition level transmitted by the UE and the repetition number to be actually applied by the eNB may be predefined or may be transmitted from the UE to the eNB using an RRC signaling method.

Transmission method of repetition level

Direct transmission of repetition level:

When the maximum number of repetition levels is 16, the UE may directly transmit the repetition level using a container having a total of 4 bits. In this case, the UE may transmit an index having highest efficiency of repetition level/modulation/coding rate combinations satisfying a BLER of 10% or less based on a reference resource. At this time, the coding rate is a coding rate per subframe which does not consider repetition. Alternatively, a lowest repetition level among repetition levels satisfying a certain target MCS (which is predefined or configured by the eNB via RRC signaling) may be transmitted.

Alternatively, as shown in the following table, a table or equation may be designated to transmit the repetition level.

TABLE 15

| Index | repetition level (dB) |
|---|---|
| 0 | 0 |
| 1 | 3 |
| 2 | 5 |
| 3 | 7 |
| 4 | 10 |
| 5 | 12 |
| 6 | 14 |
| 7 | 16 |

The content of the repetition level of the above table may be modified to a “maximum repetition level ratio” or an “offset to a current repetition level” as described in “transmission via DCI” of Method 1-2, instead of direction transmission of the repetition level.

The above table may be extended as follows such that the repetition level is separately transmitted per channel (or per uplink/downlink).

TABLE 16

| | repetition level for | repetition level for |
|---|---|---|
| Index | PDCCH (dB) | PDSCH (dB) |
| 0 | 0 | 0 |
| 1 | 4 | 0 |
| 2 | 4 | 4 |
| 3 | 8 | 4 |
| 4 | 8 | 8 |
| 5 | 12 | 8 |
| 6 | 12 | 12 |
| 7 | 16 | 16 |

The repetition level may be changed according to the transmission location of the CQI.

The UE may calculate a CQI on the assumption of two or more repetition levels and report the CQI corresponding to each repetition level to the eNB. In this case, the repetition level may be configured by the eNB. If the UE receives two repetition levels configured by the eNB, two CQI transmission containers should be predefined at the UE and the eNB and the repetition levels and the CQI containers should be mapped. The UE may calculate two CQIs on the assumption of the repetition levels and transmit the CQIs in specified containers. In this case, the repetition level assumed to calculate the CQI is determined depending on which container is used.

The repetition level is transmitted via a new CQI table (QPSK only, repetition level included)

Use of a new CQI table: Instead of separate transmission of the CQI and the repetition level assumed upon CQI calculation, a new CQI table including the repetition level assumed upon CQI calculation along with modulation and coding rate may be used. In the case of using the following table, when the repetition level is determined, a highest index of repetition level/modulation/coding rate combinations satisfying a BLER of 10% or less of a reference resource may be transmitted. At this time, the coding rate is a coding rate per subframe which does not consider repetition.

TABLE 17

| CQI | Repetition | | |
|---|---|---|---|
| index | Level (dB) | Modulation | Code rate × 1024 |
| 0 | Out of range | | |
| 1 | 16 | QPSK | 78 |
| 2 | 14 | QPSK | 78 |
| 3 | 12 | QPSK | 78 |
| 4 | 10 | QPSK | 78 |
| 5 | 8 | QPSK | 78 |
| 6 | 6 | QPSK | 78 |
| 7 | 4 | QPSK | 78 |
| 8 | 2 | QPSK | 78 |
| 9 | 0 | QPSK | 78 |
| 10 | 0 | QPSK | 120 |
| 11 | 0 | QPSK | 193 |
| 12 | 0 | QPSK | 308 |
| 13 | 0 | QPSK | 449 |
| 14 | 0 | QPSK | 602 |
| 15 | 0 | 16QAM | 378 |

Alternatively, as shown in the following table, a table for specifying a repetition level for a specific target (e.g., QPSK, coding rate 120×1024) defined previously or received from the eNB via RRC signaling may be defined to transmit the index. In this case, as the repetition level, a lowest repetition level of repetition levels satisfying the specified target may be fed back.

TABLE 18

| CQI | Repetition Level for QPSK, |
|---|---|
| index | code rate 120 × 1024 |
| 0 | Out of Bound |
| 1 | 15 |
| 2 | 14 |
| 3 | 13 |
| 4 | 12 |
| 5 | 11 |
| 6 | 10 |
| 7 | 9 |
| 8 | 8 |
| 9 | 7 |
| 10 | 6 |
| 11 | 5 |
| 12 | 4 |
| 13 | 3 |
| 14 | 2 |
| 15 | 0 |

A method of, at the eNB, configuring two or more targets and transmitting repetition numbers is also possible.

The size of the above table may be changed according to feedback container.

Periodic CSI reporting method:

The UE measures channel information and then calculates and transmits a required repetition level and CSI. The eNB may configure a repetition level to be used by the UE based on the CSI and repetition level transmitted by the UE and perform scheduling and data transmission.

Repetition level transmission container

An existing container is reused to transmit the repetition level.

Use of RI container:

For low power consumption and cost reduction of the MTC UE, a method of restricting a maximum transmission layer to 1 is being considered. In this case, since RI is no longer transmitted in a periodic CSI report, the repetition level assumed for CSI calculation may be transmitted via the RI container. In this case, one of a maximum of 8 kinds (3 bits) of repetition levels may be set as the repetition level.

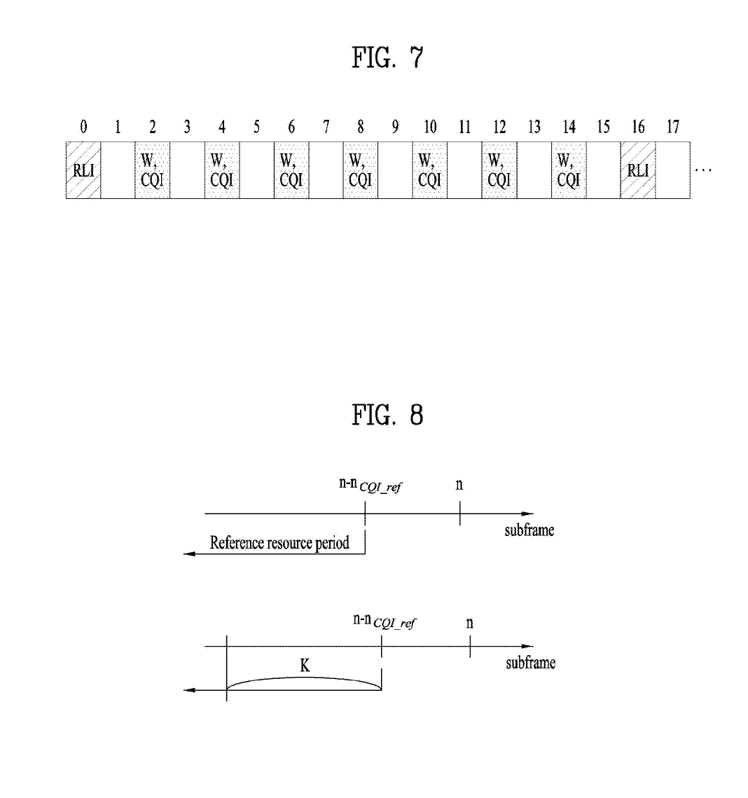

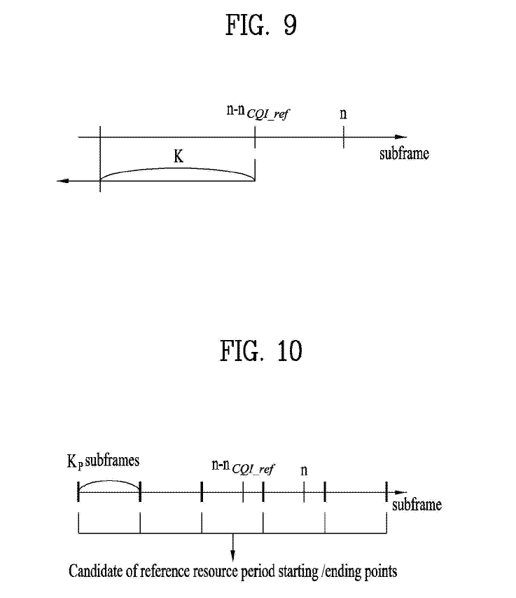

FIG. 7 shows an example of transmitting a repetition level via a repetition level indicator (RLI) instead of RI.

Transmission of repetition level via container for second codeword:

For the above-described reason, since a CQI report for a second codeword is not necessary, the repetition level assumed for CSI calculation may be transmitted via a corresponding container. In this case, one of a maximum of 8 kinds (3 bits) of repetition levels may be set as the repetition level.

Alternatively, for the above-described reason, since a CQI report for a second codeword is not necessary, a container having a total of 7 bits including a corresponding container is possible.

New feedback mode—Addition of new container for repetition level transmission:

A separate container for transmitting the repetition level assumed for CSI calculation and a new feedback mode using a corresponding container may be defined and used.

For an MTC UE capable of performing CE, a method of defining different repetition levels according to subbands and enabling UEs which use respective subbands to use repetition levels corresponding thereto is considered. In this case, for aperiodic CSI, transmission of a separate repetition level is omitted and, instead, a subband index is used, and vice versa.

Reference Resource for CSI Measurement

A reference resource is a subframe used as a criterion upon CSI calculation. The UE assumes that PDSCH transmission is performed via the channel of a corresponding subframe, calculates CSI and transmits CSI corresponding to a definition to the eNB based on the calculated result. If the UE capable of performing CE assumes that one PDSCH is transmitted via one subframe and determines a CQI, a CQI remarkably lower than a CQI obtained by performing CE by the UE is obtained. This may violate an existing CQI definition—a highest CQI index satisfying a BLER of 10%. Accordingly, in order to transmit the CSI considering CE, the UE needs to consider CE to be performed thereby even upon CSI measurement.

Method 1: Subframes corresponding to the repetition level to be used by the UE are measured to calculate CSI.

For example, when the UE assumes a repetition number N for a repetition level K upon CSI calculation, the UE may actually measure a channel during N subframes to calculate CSI. The reference resource includes an existing reference resource and may be N available subframes prior thereto. For example, in the case of a FDD periodic CSI report of transmission mode (TM) 9, when a report timing of CSI is an n-th subframe, the reference resource may be (n−4)-th subframe to (n−4−N+1) subframe (when the subframes included in this period are all available). This method is straightforward, but blindly measures and stores N subframes. Therefore, the burden of the UE increases. In order to calculate CSI for several repetition numbers, the channel should be stored based on a highest repetition number and thus the burden of the UE further increases. In addition, in TDD, since UL/DL subframes may be changed during N subframes, the channel should be measured during a longer time.

In an aperiodic CSI request, N available subframes after previous N available subframes from a time when the request is received may be used as the reference resource. In this case, channel information is not blindly measured and stored but is measured after the request. Instead, the report time is delayed by N subframes and the timing of the PUSCH (or the PUCCH), via which the CSI will be transmitted, needs to be redefined.

Method 2: The reference resource is maintained and the UE emulates multiple reference resources.

Although the UE actually uses one subframe as a reference resource, the CSI is calculated on the assumption that the PDSCH is transmitted via the channel several times.

Method 2-1: The UE may assume that the same subframe as a corresponding subframe is repeated as N times and transmit CSI on the assumption that the PDSCH is repeatedly transmitted during N subframes. This method is simple, several reference resources do not need to be stored and the definition of the reference resource does not need to be changed. However, the time-varying property of the channel may not be appropriately applied. In addition, CSI measurement efficiency depends on the emulation of the UE.

Method 2-2: The UE may apply a predetermined power boosting ratio to an RS measured in a corresponding subframe and emulate several-time reception of the corresponding subframe. The UE may receive the above power boosting level from the eNB using a method for signaling a repetition number or the UE may feed the power boosting level back to the eNB.

Handling A-CSI During RACH

During a random access procedure, the eNB may carry an aperiodic CSI request in msg2 in order to know the channel information of the UE. The UE calculates CSI for the aperiodic CSI request and transmits the CSI upon transmitting a next PUSCH. When the reception time of msg2 is a subframe n, this PUSCH is transmitted in a subframe (n+k). When a UE delay field is 0, k is a first available UL subframe satisfying k≧6. In this case, the reference resource of the aperiodic CSI report is an (E)PDCCH or PDSCH in which msg2 is transmitted.

If the UE for transmitting the aperiodic CSI is a low-cost MTC UE capable of performing CE, the UE may consider the repetition level to be used thereby in CSI. In this case, the reference resource and the PUSCH transmission time may be used as follows.

Method 1: The UE measures subframes corresponding to the repetition level to be used thereby to calculate CSI.

When the repetition number necessary for the repetition level is N, the UE should measure the channel during a total of N subframes including a subframe in which the aperiodic CSI request is received. If subframe n to subframe n+N−1 are defined as the reference resource, the UE measures the channel during a total of N subframes to report CSI. In this case, the PUSCH transmission time when the CSI is transmitted in correspondence with msg2 is at least max((n+N−1)+4, n+k).

Alternatively, subframe n−N+1 to subframe n may be defined as the reference resource. In this case, the PUSCH transmission time when the CSI is transmitted in correspondence with msg2 may correspond to a subframe n+k. However, the UE should measure N subframes in advance, for random access using an RACH.

Method 2: The reference subframe is maintained and the UE emulates multiple reference resources.

In this case, the reference resource and uplink transmission instance may not be changed.

An aperiodic CSI trigger using RAR (msg2) may be received before reception of a configuration of a repetition level. In this case, a maximum repetition level supported by the network may be assumed to calculate a CQI, a predefined maximum repetition number may be assumed to calculate a CQI or m corresponding to a period m, to which frequency hopping is applied, may be used as a repetition number. For example, when frequency hopping occurs every 5 msec, m=5 may be assumed to perform CQI measurement. Alternatively, the UE may assume a repetition number K corresponding to the coverage level used in the PRACH to perform measurement. The repetition number used by the UE may be configured by the network or the repetition number corresponding to the CE level thereof (the CE level used in the PRACH or the CE level configured by the network) may be pre-configured and used. In this case, when the UE performs a random access procedure again or re-configures a CE level, the repetition number used by the UE may be dynamically changed. Since such a repetition number is an important parameter when measurement is performed in consideration of repetition, the network and the UE need to have the same value. Alternatively, such a repetition number may be configured by the UE. When the aperiodic CQI is triggered, measurement may be performed within a duration configured by the network via DCI. Even when such a duration is less than an actually necessary repetition number, the UE may calculate and report a maximum value. Alternatively, the value of the duration from the aperiodic CQI trigger to reporting may be semi-statically configured. In consideration of this, the UE may be configured to calculate an appropriate CQI value.

The following methods may be considered as the method for configuring multiple reference resources.

Method 1: a subframe as reference resources

Method 2: m consecutive subframes as reference resources, where m is multichannel estimation window width

Method 3: N consecutive subframes as reference resources, where N is repetition number

Method 4: m′ non-consecutive subframes as reference resources, where m′ is multichannel estimation subframe number or number of subframes used for frequency hopping across narrowbands

Method 1 may be inaccurate because the UE should emulate the transmission effects of multiple subframes based on information on one subframe. Accordingly, like Method 2 and Method 3, two or more subframes may be defined as the reference resources to enable the UE to more accurately measure a CQI considering repetition. However, a time required for channel measurement may be small.

In this case, when the UE receives an aperiodic CSI request, if a narrowband in which the aperiodic CSI request is transmitted is not included in a subband list measured by the UE, the subframe is not regarded as being valid. If the subframe corresponds to the above condition and thus is not valid, a first valid downlink subframe prior to the subframe is regarded as a reference resource.

In Method 2, m is multichannel estimation window such that the UE applies a more accurate repetition effect via multiple subframes. The repetition effect may not be appropriately applied according to the size of m, but a time required for measurement may be relatively small.

In Method 3, N is a repetition number to be assumed for CQI calculation. Channel estimation is performed during subframes corresponding to the repetition number specified to or determined by the UE. Since the channel is measured by the specified repetition number, the repetition effect may be more appropriately applied, but a time required for channel measurement is large and outdating of the measured channel information may adversely affect channel measurement performance.

In Method 4, a period until m′ subframes corresponding to the valid downlink subframes defined below are present may be configured as a reference resource period and a CQI may be calculated using the m′ subframes as the reference resource. In this case, in Method 3, a period until N subframes corresponding to the valid downlink subframes defined below are present may be configured as a reference resource period and a CQI may be calculated using the N subframe as the reference resource, like Method 4.

In this case, when the CQI is reported in the subframe n, the assumed reference resource is decided. For convenience, assume that the size of this period is K.

In a periodic report, the reference resource becomes a valid downlink subframe of subframes prior to n−n_{CQI}_{_}_{ref}. Accordingly, as shown in FIG. 8, K may be set to a period in the backward direction of n−n_{CQI}_{_}_{ref}. In an aperiodic report, when the UE receives an aperiodic CSI request in n−n_{CQI}_{_}_{ref}, the aperiodic CSI may be interpreted as being transmitted in the subframe n.

In this case, the UE may calculate CQI considering repetition using a period from n−n_{CQI}_{_}_{ref} to n−n_{CQI}_{_}_{ref}−K as a reference resource period. When there is no restriction, K=m or K=N may be configured and used for Method 2 or Method 3.

In addition, operation for restricting the reference resource period K to a specific period may be possible. As the configuration of the reference resource period K, a start point Kₛ of the reference resource period and an end point K_{E} of the reference resource period may be specified with respect to the UE.

In addition, K_{S} and K_{E} may be determined from predetermined candidates.

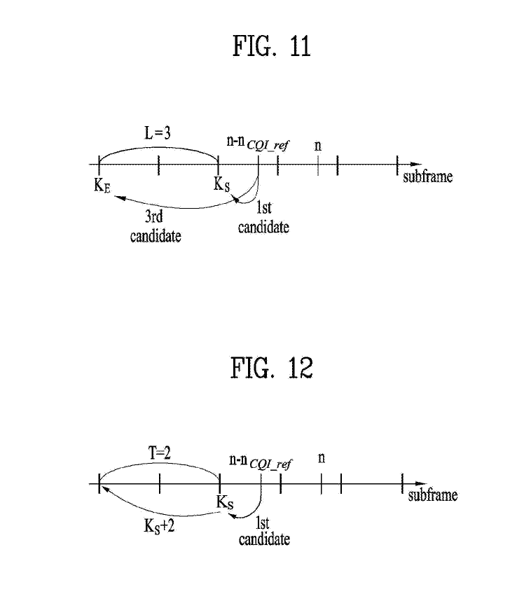

FIG. 10 shows K_{S} and K_{E} candidates divided into K_{P} subframes. K_{S} and K_{E} may be determined from the above candidates. In this case, the reference resource period may be from a specified K_{S} to a specified K_{E} among K_{S} and K_{E} candidates prior to n−n_{CQI}_{_}_{ref}. For example, K_{S} may be defined as an m-th candidate of K_{S} and K_{E} candidates prior to n−n_{CQI}_{_}_{ref} and K_{E} may be defined as an L-th candidate of K_{S} and K_{E} candidates prior to n−n_{CQI}_{_}_{ref}. In this case, the period from M to M+(L−1) may be a reference resource period. FIG. 11 shows an example of M=1 and L=3. In this case, K=K_{P}×(L−M).

Alternatively, when the size T of the period is directly given in candidate period units, a period from K_{S} to K_{S}+T may be a reference resource period. If K_{S} becomes a recent candidate among K_{S} and K_{E} candidates prior to n−n_{CQI}_{_}_{ref} and the size of the period is 2, the reference resource period shown in FIG. 12 may be defined. That is, in this case, K=T×K_{P}.

When the reference resource period is defined in the predetermined candidates, if a period for a specific repetition number N is defined, T=┌N/K_{P}┐ or L=S+┌N/K_{P}┐ may be defined.

When the UE receives the aperiodic CSI request, UL grant may be repeated and transmitted. At this time, when the transmission time of the aperiodic CSI is n, the UE may assume that the last subframe of the repeated UL grant is a reference resource.

In this case, when the UE receives the aperiodic CSI request, in a subframe satisfying the reference resource condition (e.g., the last subframe of the repeated UL grant), if a narrowband in which the aperiodic CSI request is transmitted is not included in a subband list to be measured by the UE, the subframe is not regarded as being valid. In this case, prior to the corresponding subframe, in the direction from the end to the start of the repetition, a first valid downlink subframe in which the aperiodic CSI request is transmitted in the narrowband included in the subband list to be measured by the UE is regarded as a reference resource.

Alternatively, in the direction from a subframe, in which repetition of UL grant starts, to the end of repetition, a first valid downlink subframe in which the aperiodic CSI request is transmitted in the narrowband included in the subband list to be measured by the UE is regarded as a reference resource.

If multiple reference resources are considered, a reference resource period defined in the backward direction from the last subframe of UL grant may be defined.

When the reference resource period is given, all subframes in the reference resource period may be used as reference subframes. In this case, the UE may use the subframe in the reference resource period for CQI calculation even when the subframe is not actually used for transmission using repetition. In this case, although the amount of resources for CQI calculation increases, subframes which cannot actually be used may make CQI calculation inaccurate.

In contrast, only a valid downlink subframe in the reference resource period may be used as the reference subframe. The subframe satisfying the following condition in terms of time is defined as a valid downlink subframe in the current LTE-A specification.

it is configured as a downlink subframe for that UE, and

in case multiple cells with different uplink-downlink configurations are aggregated and the UE is not capable of simultaneous reception and transmission in the aggregated cells, the subframe in the primary cell is a downlink subframe or a special subframe with the length of DwPTS more than 7680·Tₛ, and

except for transmission mode 9 or 10, it is not an MBSFN subframe, and

it does not contain a DwPTS field in case the length of DwPTS is 7680·Tₛ and less, and

it does not fall within a configured measurement gap for that UE, and

for periodic CSI reporting, it is an element of the CSI subframe set linked to the periodic CSI report when that UE is configured with CSI subframe sets, and

for a UE configured in transmission mode 10 with multiple configured CSI processes, and aperiodic CSI reporting for a CSI process, it is an element of the CSI subframe set linked to the downlink subframe with the corresponding CSI request in an uplink DCI format, when that UE is configured with CSI subframe sets for the CSI process.

According to the embodiment of the present invention, the definition of the valid downlink subframe may be added as follows.

a subframe not used as a gap subframe (switching subframe) for frequency re-tuning for frequency hopping (subband hopping) or a subframe other than a subframe configured as a gap by a network for re-tuning (at this time, a gap subframe which will be newly generated in order to receive a cross-subband scheduled PDSCH may not be included in an invalid subframe);

a subframe configured as a subframe in which the MTC UE may receive downlink data and/or a control channel;

a subframe used as a measurement gap when a measurement gap for subband measurement is configured for the MTC UE;

a subframe configured to monitor a subband included in a subband set for CQI calculation; and

a subframe for performing CSI measurement within T_{CSI} in a monitored subband

T_{CSI} is a duration when a channel measurement result value is assumed to be valid. This may be configured via RRC signaling from the eNB or may be predefined. For simplification, only a subframe in which a CSI-RS is transmitted may be regarded as a valid subframe.

When the UE receives the aperiodic CSI request, the UE may configure a reference resource period in the forward direction from the corresponding subframe. This leads to elimination of the need to buffer information on the reference resource. In the forward direction, when the aperiodic CSI request is received in a subframe n−n_{CQI}_{_}_{ref}, the UE may configure the reference resource period from a subframe n−n_{CQI}_{_}_{ref} to a subframe n−n_{CQI}_{_}_{calc}. n−n_{CQI}_{_}_{calc} is a time required for the UE to calculate the CQI based on the channel information and may be configured by the eNB via RRC signaling or may be predefined. n−n_{CQI}_{_{—hd calc}} may be configured when a time gap for measuring subbands other than a monitoring subband, such as frequency hopping, is configured. FIG. 14 shows the case in which the aperiodic CSI request is received in a subframe n−n_{CQI}_{_}_{ref}.

In this case, the UE calculates the CQI with the repetition effect using the reference resource in the reference resource period configured by the above method starting from the subframe n.

In this case, as shown in Table 13, when a subframe set from the start point to the end point of the measurement period is determined, after an aperiodic trigger is received, the UE may start channel measurement from the corresponding subframe or the subsequent subframe thereof. If this subframe is n−n_{CQI}_{_}_{ref} and measurement is performed over K subframes, the UE may count valid subframes by K and then add UE processing latency of 3 msec to transmit the CSI in the subsequent uplink subframe. In TDD, when the aperiodic CSI is requested, in order to prevent timing deviation, if repetition is not used in one radio frame and transmission is configured in a subframe n+k (trigger message transmission is finished in a subframe n), several radio frames may be skipped in consideration of repetition and then transmission may be performed in the same subframe index. For example, if it is assumed that repetition K is 15 and all subframes are valid, the UE may start transmission after two radio frames.

In normal coverage, even when repetition is not used, aperiodic CQI trigger timing may be changed according to the number of narrowbands in which the UE should perform measurement. In this case, the following method is applicable in order to set timing.

When a trigger is received in a subframe n and it is assumed that a subframe n+k is a subframe in which a PUSCH is transmitted at TDD timing, if the aperiodic CQI triggered in the subframe n further needs latency of “L”, the UE may assume that the aperiodic CSI request is triggered in the downlink subframe n+L and perform transmission in the subframe corresponding to the subframe n+(L−1)+k1. At this time, k1 corresponds to a subframe assuming L=1 when the aperiodic CSI request is received in the subframe n+L. At this time, latency of L may be a value for fixing timing when the UE may actually perform measurement. The value L may be changed according to the number of narrowbands of the UE or the number of UL/DL subframes. Accordingly, a table for the value L may be configured and used. For example, when the number of narrowbands is 3, the value L for DL/UL configuration 1 is as follows.

TABLE 19

| # of subframe in a radio frame | | | | | | | | | |
|---|---|---|---|---|---|---|---|---|---|
| 1 | 2 | 3 | 4 | 5 | 6 | 7 | 8 | 9 | 10 |

| | | | | | |
|---|---|---|---|---|---|
| L | 10 | 8 | 5 | 6 | 5 |

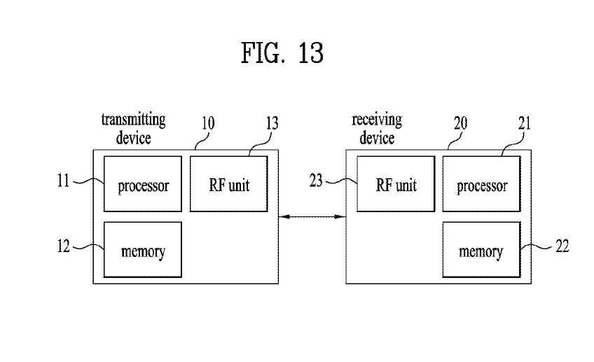

FIG. 13 is a block diagram of a transmitting device 10 and a receiving device 20 configured to implement exemplary embodiments of the present invention. Referring to FIG. 13, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

The transmitting device and/or the receiving device may be configured as a combination of one or more embodiments of the present invention.

The embodiments of the present application has been illustrated based on a wireless communication system, specifically 3GPP LTE(-A), however, the embodiments of the present application can be applied to any wireless communication system in which interferences exist.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As is apparent from the above description, the embodiments of the present invention can efficiently receive and measure a reference signal (RS) in a wireless communication system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting a channel state report considering repetition for coverage enhancement in a wireless communication system, the method being performed by a terminal, the method comprising:
receiving information on a reference resource period;
determining a plurality of valid downlink subframes in the reference resource period using the information; and
calculating channel state information in the plurality of valid downlink subframes, wherein the number of valid downlink subframes is equal to the number of the repetition.

2. The method according to claim 1, wherein the valid downlink subframes include a subframe not used as a gap subframe for frequency re-tuning for subband hopping or a subframe other than a subframe configured as a gap by a network for re-tuning.

3. The method according to claim 1, wherein the valid downlink subframes include a subframe configured as a subframe in which the terminal receives downlink data and/or a control channel.

4. The method according to claim 1, wherein the valid downlink subframes include a subframe configured as a measurement gap when the measurement gap for subband measurement is configured for the terminal.

5. The method according to claim 1, wherein the valid downlink subframes include a subframe configured to monitor a subband included in a subband set for which the terminal calculates a channel quality indicator.

6. The method according to claim 1, wherein:
the valid downlink subframes include a subframe in which the terminal performs channel measurement within a time duration in a monitored subband, and
the time duration includes a duration when a result value of channel measurement is assumed to be valid.

7. The method according to claim 1, wherein the reference resource period includes subframes after a subframe in which a request for an aperiodic channel state information is received.

8. The method according to claim 1, wherein the information on the reference resource period includes information on a start subframe and last subframe of the reference resource period.

9. The method according to claim 1, wherein the information on the reference resource period includes a start subframe of the reference resource period and information on a length of the reference resource period.

10. A terminal configured to transmit a channel state report considering repetition for coverage enhancement in a wireless communication system, the terminal comprising:
a radio frequency (RF) unit; and
a processor configured to control the RF unit,
wherein the processor receives information on a reference resource period, determines a plurality of valid downlink subframes in the reference resource period using the information, and calculates channel state information in the plurality of valid downlink subframes, and
wherein the number of valid downlink subframes is equal to the number of the repetition.
